(19) United States
(12) Patent Application Publication
(10) Pub. No.: US 2004/0055017 A1
(43) Pub. Date: Mar. 18, 2004

(54) Method and system to generate and transmit authoring data associated with distributed content, for inclusion within authored content

(76) Inventors: Alain Delpuch, Les Essarts Leroi (FR); Frederic Tapissier, Paris (FR); Vincent Dureau, Palo Alto, CA (US); Steven Szymanski, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/661,160

(22) Filed: Sep. 12, 2003

Related U.S. Application Data
(60) Provisional application No. 60/410,593, filed on Sep. 13, 2002.
(60) Provisional application No. 60/417,538, filed on Oct. 9, 2002.

(51) Int. Cl. H04N 7/173

(52) U.S. Cl. 725/110

(57) ABSTRACT

A system to enable authoring of content within an interactive television environment communicates, from a source system, television content to a receiver system, the television content to be presented to a user by the receiver system. Authoring data, associated with the television content, is also communicated from the source system to the receiver system. An authoring application is communicated from the source system to the receiver system, the authoring application being executable by the receiver system to enable the user to author content utilizing the authoring data. The authoring application may include messaging logic to enable the inclusion of the content in a message.

This application claims the benefit of U.S. Provisional Application No. 60/410,593 filed Sep. 13, 2002 and U.S. Provisional Application No. 60/417,538 filed Oct. 9, 2002. The present application furthermore incorporates by reference each of the identified provisional patent applications.

### FIELD OF THE INVENTION

The present invention relates generally to the field of electronic communications, and, more specifically, communication of data that is available to user to include in authored content.

### BACKGROUND OF THE INVENTION

Interactive television systems operate to enhance the experience of a content consumer in a number of ways. Firstly, content producers and/or distributors are able to provide enhanced services and features to a consumer. For example, interactive television systems may be capable of executing interactive television (iTV) applications that supplement and enhance the viewing experience of a user. A wide range of interactive television applications may be provided to a user via an interactive television system, ranging from an interactive program guides (IPGs) to games and the like.

Interactive television applications may also be attractive to a content consumer because, such applications elevate a television viewing experience from a purely passive activity to an active, or interactive, activity. For example, a shopping interactive television application may enable a user to interactively place orders for products being advertised via a television broadcast.

An interactive television application is typically delivered from a headend of a broadcast service provider to a set-top box (STB) of a consumer as part of a broadcast transmission. Such a broadcast may include a television content portion (e.g., audio and video) and an interactive portion. The interactive portion may include application code and control information for an interactive television application. The broadcast service provider typically combines the television content and interactive portions of the broadcast into a single signal that is broadcast to a user location.

At the user end, a user device (e.g., the set-top box (STB)) receives the broadcast, extracts the interactive portion thereof, and composes and executes one or more interactive television applications that are embodied in the interactive portion of the broadcast.

The user device, in addition to extracting and executing the interactive television application may also be provided with a transmission capability whereby the user device can communicate from the user location back to a broadcast service provider or to other users, for example via a network (e.g., the Internet).

### SUMMARY OF THE INVENTION

According to one aspect of the present invention, there is provided a method to enable user authoring of content within an interactive television environment. Television content is communicated to a receiver system, the television content to be presented user by the receiver system. Also at the source system, authoring data, associated with the television content, is communicated to the receiver system. At the source system, an authoring application is communicated to the receiver system, the authoring application being executable by the receiver system to enable the user to author content utilizing the authoring data.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a diagrammatic representation of an exemplary interactive television environment within which the present invention may be deployed.

FIG. 2 is a block diagram providing architectural details regarding a headend system and a set-top box, according to an exemplary embodiment of the present invention.

FIG. 3 is a diagrammatic representation of a data stream that may be outputted from a multiplexer of a headend system, according to one embodiment of the present invention.

FIG. 4 is a block diagram showing authored content that may be authored by a user utilizing a set-top box executing an authoring application, according to one embodiment of the present invention.

FIG. 5 is a block diagram illustrating details regarding the deployment of various aspects of one embodiment of the present invention within the context of an interactive television environment.

FIG. 6 is a block diagram illustrating architecture of an authoring application, according to one embodiment of the present invention.

FIG. 7 is a flowchart illustrating a method, according to one exemplary embodiment of the present invention, to enable user authoring of content within an interactive television environment.

FIG. 8 is a flowchart illustrating a method, according to an exemplary embodiment of the present invention, to generate authored content that includes authoring data transmitted to an authoring application from a headend system.

FIGS. 9-14 illustrate a series of user interfaces, according to one exemplary embodiment of the present invention, which may be presented by an authoring application so as to enable a user to author and transmit authored content.

FIG. 15 is a flowchart illustrating a method, according to an exemplary embodiment of the present invention, to associate authoring data with other distributed data, and to communicate the authoring data to a user for inclusion within authored content.

FIG. 16 is a block diagram illustrating a machine, in the exemplary form of a computer system, that may store and execute a set of instructions that cause the machine to perform any of the methods described herein.

### DETAILED DESCRIPTION

A method and a system to enable user authoring of content within an interactive television environment are described. In the following description, for purposes of explanation, numerous specific details are set forth in order to provide a thorough understanding of the present invention. It will be evident, however, to one skilled in the art that the present invention may be practiced without these specific details.

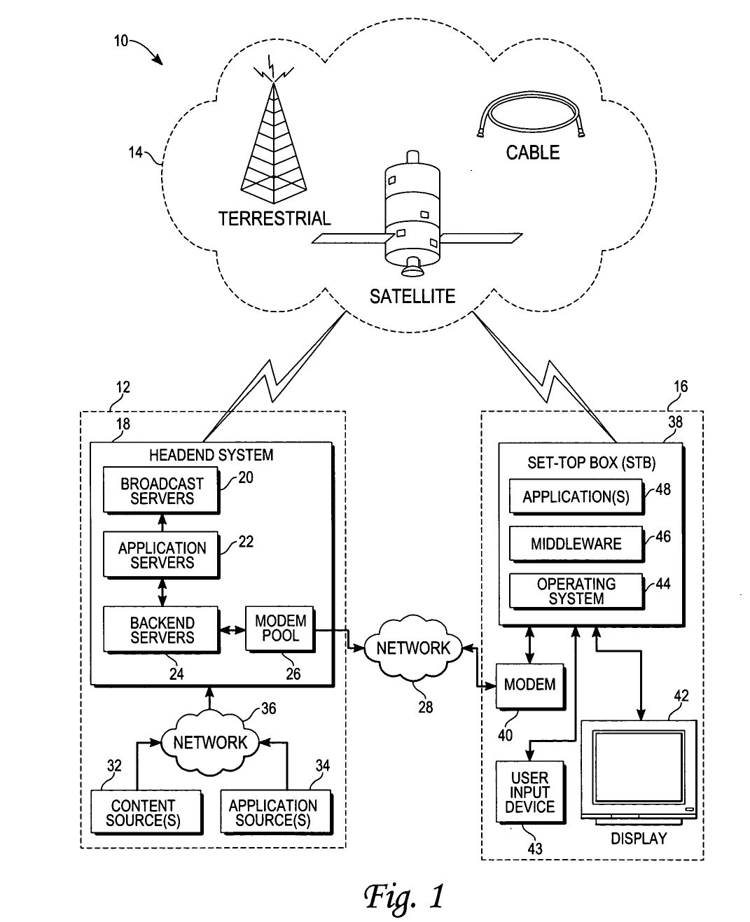

FIG. 1 is a diagrammatic representation of an exemplary interactive television environment 10, in conjunction with which the present invention may be deployed. The interactive television environment 10 includes a source system 12 that communicates data (e.g., television content and interactive application data) via a distribution system 14 to a receiver system 16.

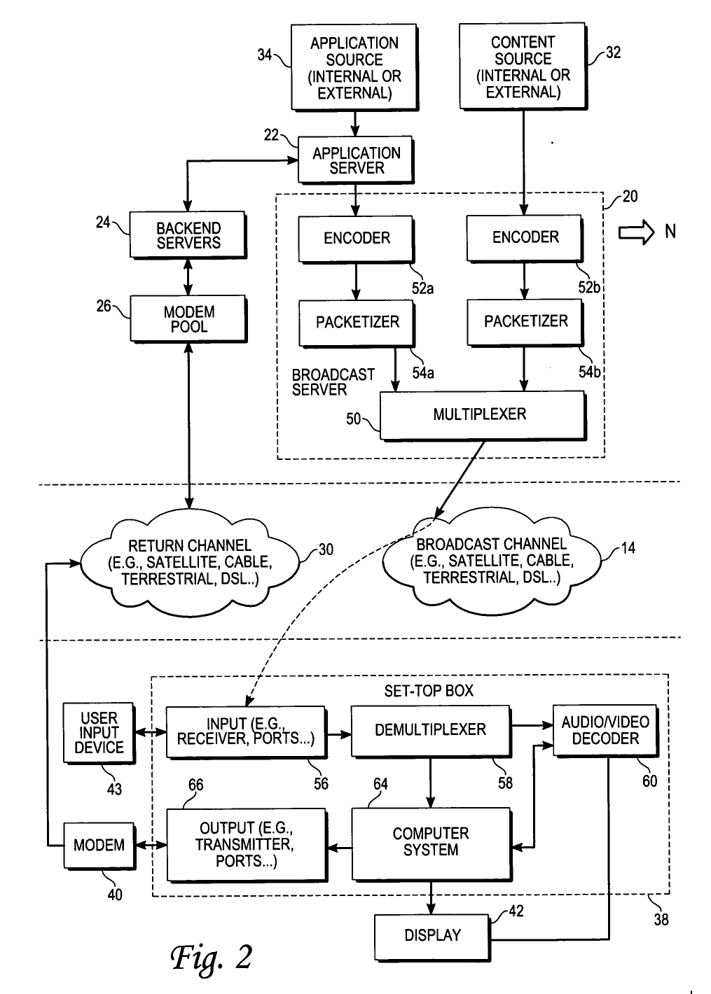

Turning first to the source system 12, a headend system 18 operates to communicate the data as a broadcast transmission. To this end, the headend system 18 is shown to include one or more broadcast servers 20 and one or more application servers 22. Each of the broadcast servers 20 may operate to receive, encode, packetize, multiplex, and broadcast data from various sources and of various types. While the exemplary embodiment is described herein as transmitting data from the headend system 18 as a broadcast, it will be appreciated that the relevant data could also be unicast or multicast from the source system 12 via the distribution system 14 to the receiver system 16. In various embodiments, data could also be transmitted from the source system 12 via a network connection to the receiver system 16. Further details regarding an exemplary broadcast server 20 are provided below with reference to FIG. 2.

Each application server 22, in one exemplary embodiment of the present invention, serves to compile and provide interactive data modules to the broadcast server 20. The interactive data modules may include data (e.g., updated statistics and scores for sporting events, news feed, etc.) utilized by an interactive television application. An application server 22 also includes multiplexing functionality to enable multiplexing of, for example, interactive television applications and associated data with audio and video signals received from various sources. An application server 22 may also have the capability to feed (e.g., stream) multiple interactive television applications to one or more broadcast servers 20 for distribution to the receiver system 16. To this end, each application server 22 may implement a so-call “carousel”, whereby code and data modules are provided to a broadcast server 20 in a cyclic, repetitive manner for inclusion within a transmission from the headend system 18.

The headend system 18 is also shown to include one or more backend servers 24, which are coupled to the application servers 22 and to a modem pool 26. Specifically, the modem pool 26 is coupled to receive data from the receiver systems 16 via a network 28 (e.g., the Internet) and to provide this data to backend servers 24. The backend servers 24 may then provide the data, received from the receiver system 16, to the application servers 22 and the broadcast servers 22. Accordingly, the network 28 and the modem pool 26 operate as a return channel whereby a receiver system 16 is provided with interactivity with the source system 12. Data provided to the headend system 18 via the return channel may include, merely for example, user input to an interactive television application executed at the receiver system 16 or data that is generated by the receiver system 16 and communicated to the source system 12. The return channel 30 may also provide a channel whereby programs and applications from the source system 12 are provided to the receiver system 16.

Within the source system 12, the headend system 18 is also shown optionally to receive data (e.g., content, code and application data) from external sources. FIG. 1 illustrates the headend system 18 as being coupled to one or more content sources 32 and one or more application sources 34 via a network 36 (e.g., the Internet). For example, a content source 32 could be a provider of entertainment content (e.g., movies), or a provider of real-time dynamic data (e.g., weather information). An application source 34 may be a provider of any interactive television application. For example, one or more application sources 34 may provide Electronic Program Guide (EPG) and navigation applications, messaging and communication applications, information applications, sports applications, and/or games and gaming applications.

Turning now to the distribution system 14, the distribution system 14 may, in one embodiment, support the broadcast distribution of data from the source system 12 to the receiver system 16. As shown, the distribution system 14 may comprise a satellite, cable, terrestrial or Digital Subscribers Line (DSL) network, or any combination of such networks.

The receiver system 16 is shown, in one exemplary embodiment, to include a set-top box (STB) 38 that receives data via the distribution system 14, a modem 40 for return channel communications with the headend system 18 and optionally other external systems, a user input device 43 (e.g., a keyboard, remote control, mouse etc.) and a display device 42, coupled to the set-top box 38, for the display of content received at the set-top box 38. In one exemplary embodiment, the display device 42 may be a television set.

The set-top box 38 may execute three layers of software, namely an operating system 44, middleware 46 and one or more interactive television applications 48. The middleware 46 operates to shield the interactive television application 48 from differences of various operating systems 44 and in hardware of different set-top boxes 38. To this end, the middleware 46 may provide driver Application Program Interfaces (APIs) and a library to translate instructions received from an interactive television application 48 into low-level commands that may be understood by set-top box hardware (e.g., modems, interface ports, smart card readers, etc.).

FIG. 2 is a block diagram illustrating further details regarding the architecture of a headend system 18 and a set-top box 38, as may be deployed as part of an exemplary embodiment of the present invention. Specifically, FIG. 2 shows a broadcast server 20, which may support a carousel of modules, as including a number of parallel paths that provide input to a multiplexer 50, each of the parallel paths including an encoder 52 and a packetizer 54. Each encoder 52 may operate to receive input from one or more sources. For example, the encoder 52a is shown to receive streamed application modules from the application server 22, which is in turn coupled to receive application data from one or more application sources 34. The application source 34 may be internal or external to a headend system 18. Similarly, an encoder 52b is shown coupled to receive content data from one or more content sources 32, which may again be internal or external to the headend system 18.

It will be appreciated that each broadcast server 20 may include any number of parallel paths coupled to any number of sources (e.g., application and/or content sources 34 and 36) that provide input to the multiplexer 50. Furthermore, a headend system 18 may deploy any number of broadcast servers 20.

Each of the encoders 52 operates to encode data utilizing any one or more of a number of compression algorithms, such as for example the Motion Picture Expert Group (MPEG) comparison algorithms. Each of the encoders 52 may also operate to time stamp data for synchronization purposes. It will be appreciated that certain data types may not be susceptible to encoding and may thus pass through, or by-pass, the encoder 52, and be provided to a packetizer 54 in an unencoded state.

The packetizers 54 are coupled to receive both encoded and unencoded data and to format this data into packets before eventual transmission via the distribution system 14 (e.g., a broadcast channel).

Each of the packetizers 54 provides packets to the multiplexer 50, which multiplexes the packets into a transmission signal for distribution via the distribution system 14.

The set-top box 38 of a receiver system 16 is typically coupled to a network input (e.g., a modem), cable input, satellite dish or antenna so as to receive the transmission signal, transmitted from the headend system 18 via the distribution system 14. The transmission signal is then fed to an input 56 (e.g., a receiver, port, etc.). Where the input 56 comprises a receiver, the input 56 may, for example, include a tuner (not shown) that operates to select a broadcast channel on which the transmitted signal is broadcast. The packetized transmission signal is then fed from the input 56 to a demultiplexer 58 that demultiplexes the application and content data that constitute the transmission signal. Specifically, the demultiplexer 58 provides the content data to an audio and video decoder 60, and the application data to a computer system 64. The audio and video decoder 60 decodes the content data into, for example, a television signal. For example, the audio and video decoder 60 may decode the received content data into a suitable television signal such as a NTSC, PAL or HDTV signal. The television signal is then provided from the audio and video decoder 60 to the display device 42.

The computer system 64, which may include a processor and memory, reconstructs one or more interactive television application from the application data that is provided to it by the demultiplexer 58. As mentioned above, the application data may include both application code and/or application information that is used by an interactive television application 48. The computer system 64, in addition to reconstructing an interactive television application 48, executes such an application 48 to cause the set-top box 38 to perform one or more operations. For example, the computer system 64 may output a signal to the display device 42. For example, this signal from the computer system 64 may constitute an image or graphical user interface (GUI) to be overlaid on an image produced as a result of the signal provided to the display device 42 from the audio and video decoder 60. A user input device 43 (e.g., a keyboard, remote control, mouse, microphone, camera etc.) is also shown to be coupled to the input 56, so as to enable a user to provide input to the set-top box 38. Such input may, for example, be alphanumeric, audio, video, or control (e.g., manipulation of objects presented in a user interface) input.

The computer system 64 is also shown to be coupled to the audio and video decoder 60 so as to enable the computer system 64 to control this decoder 60. The computer system 64 may also receive an audio and/ or video signal from the decoder 60 and combine this signal with generated signals so as to enable the computer system 64 to provide a combined signal to the display device 42.

The computer system 64 is also shown to be coupled to an output 66 (e.g., a transmitter, output port, etc.) through which the set-top box 38 is able to provide output data, via the return channel 30, to an external system, such as for example, the headend system 18. To this end, the output 66 is shown to be coupled to the modem 40 of the receiver system 16.

While the receiver system 16 is shown in FIGS. 1 and 2 to comprise a set-top box 38 coupled to a display device 42, it will readily be appreciated that the components of the receiver system 16 could be combined into a single device (e.g., a computer system), or could be distributed among a number of independent systems. For example, a separate receiver unit may provide input to a set-top box 38, which is then coupled to a display device 42.

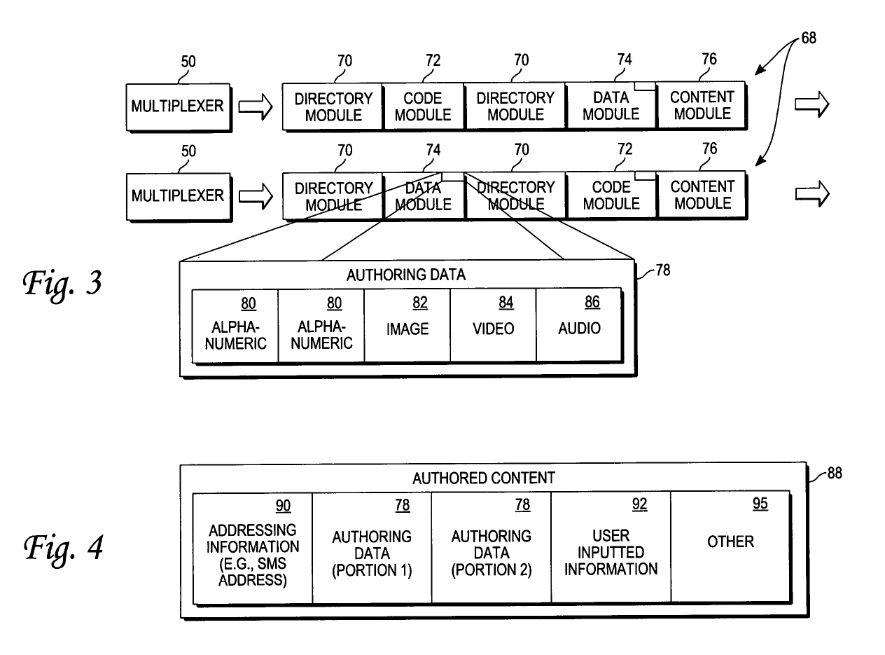

FIG. 3 is a diagrammatic representation of an exemplary data stream 68 that may, according to one exemplary embodiment of the present invention, be outputted from each of a number of multiplexers 50 deployed in headend system 18. In the exemplary interactive television environment 10, the application and content data may be presented to a broadcast server 20 as distinct modules. For example, the application data may constitute directory modules 70, code modules 72 and data modules 74. The content information may be included within content modules 76. Each of the modules 70-76 is uniquely identified as being of a particular module type. A directory module 70 has a unique identifier so as enabled it to be identified within a data stream 68 without further information. A directory module 70 furthermore contains information constituting a directory of code modules 72 and data modules 74 that form a particular interactive television application. Accordingly, a set-top box 38 may utilize a directory module 70 to identify all code modules 72 and/or data modules 74 that are required for assembling and executing an interactive television application. The directory module 70 is typically accessed and processed prior to the other modules, so as to enable the set-top box 38 to correctly identify and interpret other modules included within a data stream 68. As mentioned above, a headend system 18 will typically implement a carousel whereby the modules 70-76 are transmitted in a cyclic, repetitive manner. The set-top box 38 may executed a module manager, such as that described in U.S. Pat. No. 6,427,238, which operates to control the manner in which modules are requested by an interactive television application, received from various sources (e.g., application and content sources 34 and 32) and matched with interactive television applications requiring such modules.

Referring now specifically to FIG. 3, as noted above, a data module 74 may contain data that is pushed to, or requested by, an interactive television application, assembled at a set-top box 38 utilizing various code modules 72. FIG. 3 specifically illustrates that a data module 74 may, according to an exemplary embodiment of the present invention, include authoring data 78. The authoring data 78 may be data that is utilized by an authoring application, to be described in further detail below, to enable a user at the receiver system 16 to author content. Further, the authoring data 78 may be contextual, associated with, or otherwise related, to content data contained in content modules 76 transmitted as part of a data stream 68 together with appropriate data module 74. As shown, the authoring data 78 may include alphanumeric data 80 (e.g., text data), image data 82, video data 84 and/or audio data 86 that would be available to an authoring application for inclusion within user-authored content.

As noted, the authoring data 78 may furthermore be contextual to content data included within a content module 76. For example, where the content data is a sports event, the alphanumeric data 80 may include a current score at the sports event, as well as other statistical information. The image data 82 may include, for example, a logo of a team that is participating in the sports event. Alternatively, the image data 82 may include predefined graphic elements that would be available to a user of the authoring application to include within user-authored content. For example, the image data 82 may include any graphic elements that are typically available within the context of a drawing, or illustrating, program executable on a computer system. The image data 82 may also include advertisement images to be presented to a user of an authored application.

Similarly, the video data 84 may be a video segment to be displayed to a user and optionally made available to the user to include within user-authored content. For example, the video data 84 could be a replay video segment showing a goal scored during a sporting event. This video segment would then be available to a user to include within a message or other authored content pertaining to the sporting event. The audio data 86 may, for example, be a song (e.g., an MP# or .wav file), an audio track or excerpt, a ring tone or sound effect that would be available to a user to include within a message or other authored content.

FIG. 4 is a block diagram providing a diagrammatic representation of authored content 88, according to an exemplary embodiment of the present invention, which may be authored by a user utilizing a set-top box 38 that is executing an authoring application. As illustrated, in one exemplary embodiment wherein the authored content 88 comprises a message to be communicated from the authoring application, the authored content 88 may include addressing information 90 (e.g., an SMS, email, instant message, or other address, depending on the message type). The authored content 88 is also shown to include two portions (or subsets) of the authoring data 78, described above with reference to FIG. 3. Specifically, one embodiment of the present invention anticipates that a messaging application enables a user to select portions of received authoring data 78 and to include such portions of the authoring data 78 within authored content 88.

The authored content 88 is also shown to include user-inputted information 92, which could again comprise alphanumeric, image, video, or audio data. For example, where the authored content 88 is a message, the user inputted information 92 would typically be alphanumeric information. Of course, a message could also include image, video, or audio data. Where the authoring application is a “drawing” application, the user inputted information 92 could comprise data representing various shapes and the location of such shapes within a computer-generated drawing. The authored content 88 may also include any number of other types of information 95, including any one or more of authoring data 78 received from the source system 12, user-generated data generated at receiver system 16, or computer-generated data also generated at the receiver system 16.

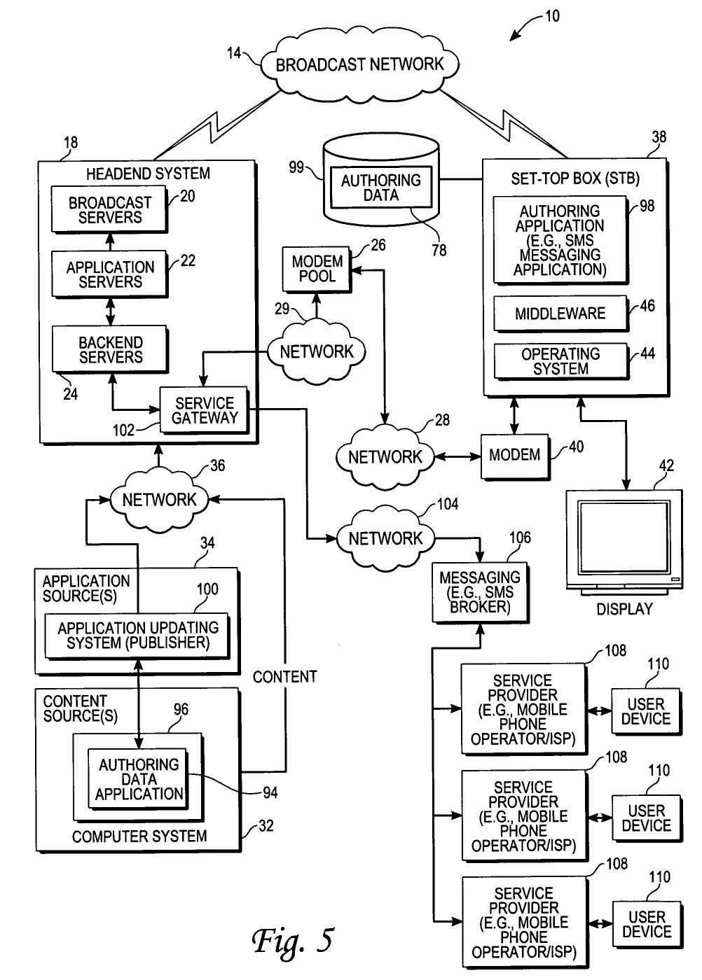

FIG. 5 is a block diagram illustrating further details regarding how various exemplary aspects of the present invention may be deployed within the context of the interactive television environment 10.

Considering first the content and application sources 32 and 34, an authoring data application 94 is shown to be executed on a computer system 96 at a content source 32. The authoring data application 94 may automatically, or under human direction, generate and/or identify the authoring data 78 that is to be communicated to an authoring application 98 executing on the set-top box 38. Specifically, the authoring data application 94 is a tool that may enable a human operator to identify any one of alphanumeric, image, video, and/or audio data 80-86 to be included within the authoring data 78. For example, where the authoring data 78 is contextual to a sports event, the data authoring application 94 may enable a human operator to identify a particular goal-scoring scene that is then included as the video data 84 within the authoring data 78. Similarly, the authoring data application 94 may function to automatically determine certain alphanumeric information pertaining to an event, or enable a human operator to input such alphanumeric information. Again, considering the example of a sports event, the authoring data application 94 may function to obtain updated score information and statistics regarding the sports event, which are then included as the alphanumeric data 80 within the authoring data 78. A human operator could also identify data, such as audio data 86 (e.g., an MP3 file) to be included within the authoring data. In another use scenario, the authoring data application 94 may automatically select data (e.g., a ring tone) to be included within the authoring data 78, the ring tone being contextual to content being broadcast from the headend system 18. For example, where the television shown “X-files” is being broadcast, a ring tone rendition of the theme song for this show could automatically be selected by the authoring data application 94. Other use scenario will be presented below.

The authoring data application 94 is shown in FIG. 5 to communicate the authoring data 78 to an application updating system 100 (or publisher), which may be deployed at an application source 34 so as to allow the application updating system 100 to include the authoring data 78 within a data module 74 associated with the authoring application 98.

The application updating system 100, in addition to generating data modules 74 that include the authoring data 78, generates code modules 72. In one exemplary embodiment, the application updating system 100 may specifically generate the code modules 72 to process (e.g., manipulate or display) the authoring data 78 included within the data modules 74. For example, code modules 72 for the authoring application 98 may be specifically generated to enable selection, manipulation and/or display of the authoring data 78. The application updating system 100 may generate the code modules 72 to provide the authoring application 98 with a broad range of functionality, examples of which will be appreciated from the various use scenarios described herein.

The application updating system 100 is shown to be coupled to the headend system 18 via the network 36, and communicates generated directory modules 70, code modules 72 and data modules 74 to the application servers 22 of the headend system 18. As illustrated in FIG. 2, the application servers 22 in turn stream the directory modules 70, code modules 72, and data modules 74 of an interactive application (e.g., the authoring application 98) to the broadcast servers 20. At the broadcast servers 20, these modules 70-74 are multiplexed with modules for other interactive applications and content modules 76 for inclusion within data streams 68, which are propagated from the headend system 18 via the distribution system 14 to a receiver system 16 as transmission signals.

Again referring to FIG. 5, the set-top box 38 is shown to host the authoring application 98 on top of the middleware 46 and the operating system 44. As will be described in further detail below, the authoring application 98 is constructed utilizing the various modules 70-74 that are included within the data stream 68, and executes so as to enable a user to author content utilizing the authoring data 78. The set-top box 38 is also shown to have associated storage 99, within which authoring data 78 received from the system 12, may be stored for presentation to a user at the receiver system 16.

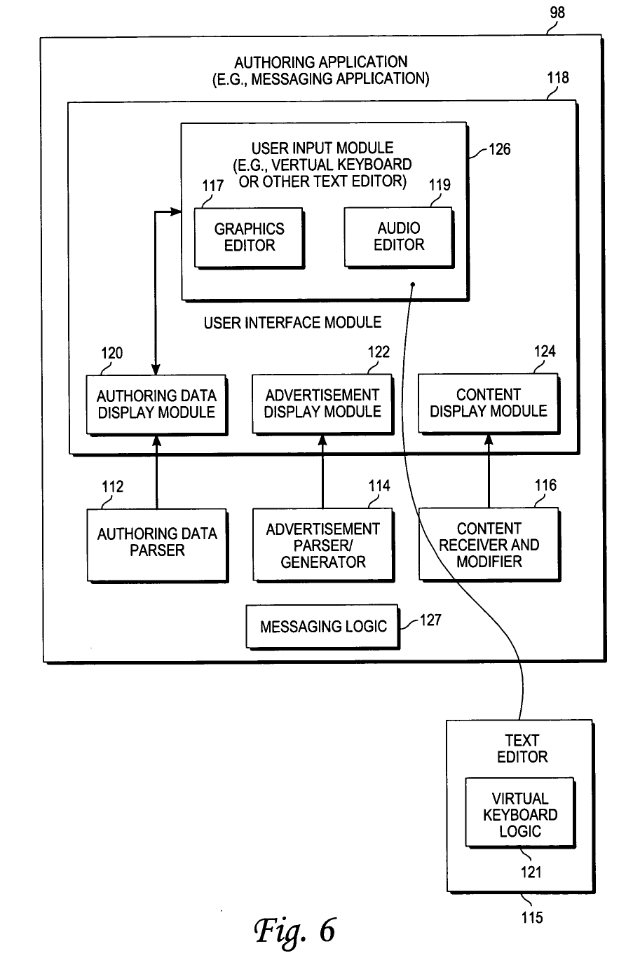

In one exemplary embodiment, the authoring application 98 may also provide messaging functionality so as to allow a user to communicate authored content to various devices and/or systems. To this end, the authoring application 98 is shown in FIG. 6 to include messaging logic 127 that provides broad messaging functionality. For example, the authoring application 98 may function as an SMS messaging application that allows users to author and communicate SMS messages to the mobile telephones of other users. In this embodiment, the authoring application 98 operates to communicate a message to a service gateway 102 that forms part of the headend system 18. Specifically, the authoring application 98 may communicate a message over the network 28 utilizing the modem 40, this message then being received at the modem pool 26, from where the message may be communicated to the service gateway 102. The modem pool 26 is located at, for example, an Internet Service Provider (ISP), and communicates with the service gateway 102 via the network 29 (e.g., the Internet).

FIG. 5 illustrates the service gateway 102 as being coupled via a network 104 to a messaging broker 106 (e.g., an SMS broker) that is able to channel messages to one of multiple service providers 108, which in turn each provide services (e.g., access services) to a multiple user devices 110. The service providers 108 may, for example, be mobile telephone operators or Internet Service Providers (ISPs). The user devices 110 may, for example, be mobile telephones, wireless communicators, Personal Digital Assistants (PDAs), Personal Computers (PCs), or any other wireless or wired devices.

In short, the modem 40, network 28 (e.g., a POTS network), modem pool 26, and the network 29 (e.g., the Internet) provide a return channel via which the authoring application 98 can communicate authored content back to the headend system 18 for communication by the service gateway 102 to user devices 110, potentially via a number of networks (e.g., a Plain Old Telephone (POTS) network, a mobile (cellular telephone) network, the Internet, or a Wi-Fi wireless network, to name but a few examples). The service gateway 102 may also facilitate bi-directional communication between a user device 110, executing an appropriate communications application, and a set-top box 38, executing the authoring application 98. Specifically, the user device 110 is able to provide a message, via an appropriate service provider 108 and messaging broker 106, to the service gateway 102, which then in turn relays the message back to the authoring application 98. The communication of messages to the authoring application 98 may occur via the return channel (e.g., the modem pool 26, network 28 and modem 40) or via the distribution system 14. Where the communication of messages to the authoring application 98 occurs via the distribution system 14, the service gateway 102 may provide data associated with a message to one or more backend servers 24 for inclusion within an application stream communicated from one or more application servers 22 to the broadcast servers 20. Alternatively, the service gateway 102 may communicate data associated with the message back to an application source 34 for inclusion within data modules 74 that are eventually communicated to the authoring application 98.

FIG. 6 is a block diagram providing a diagrammatic representation of the architecture of an exemplary authoring application 98. The authoring application 98 is shown to include an authoring data parser 112, an advertisement parser and generator 114, a content receiver and modifier 116, and a user interface module 118. The authoring data parser 112 operates to extract the authoring data 78 from data modules 74 received by the authoring application 98. The advertisement parser and generator 114 likewise parses advertisement information from within a data module 74, and generates advertisement information for display by the user interface module 118. The content receiver and modifier 116 operates to receive content information, for example from the audio and video decoder 60 of the set-top box 38.

The user interface module 118 communicates one or more user interfaces from the set-top box 38 for display on the display device 42. The user interface module 118 further includes a number of sub-modules, namely an authoring data display module 120 that is interfaced to receive the authoring data 78, appropriately formatted, from the authoring data parser 112. An advertisement display module 122 is interfaced to receive and display advertisement information generated and communicated by the advertisement parser and generator 114. A content display module 124 is interfaced to receive content information from the content receiver and modifier 116. For example, the content display module 124 may allow the incorporation of a television image within a user interface generated by the user interface module 118. A user input module 126, in the exemplary embodiment of the present invention, may generate one of more input tools for incorporation within a generated user interface that allow a user to provide input to the authoring application 98. In one embodiment, the user input module 126 may include a text editor 115, a graphics editor 117 and/or an audio editor 119. The user input module 126 may operate to present a virtual keyboard for a display within, or in conjunction with, a user interface, the virtual keyboard allowing a user to provide alphanumeric input to the authoring application 98. The user input module 126 may also provide a number of other navigation and input mechanisms, such as a text, image, or audio selection mechanism whereby a user is able to identify, select and/or edit at least a portion of authoring data 78 for inclusion within authored content 88. The user input module 126 may also allow the authoring application 98 to receive alphanumeric or other input from the user for inclusion within, or modification of, the authored content 88, and also allow the authoring application 98 to receive addressing information 90 to facilitate the addressing of messages that may be generated by the authoring application 98. It will of course be appreciated that the authoring application 98 may include a number of other modules that support functionality of the authoring application 98 that is described herein.

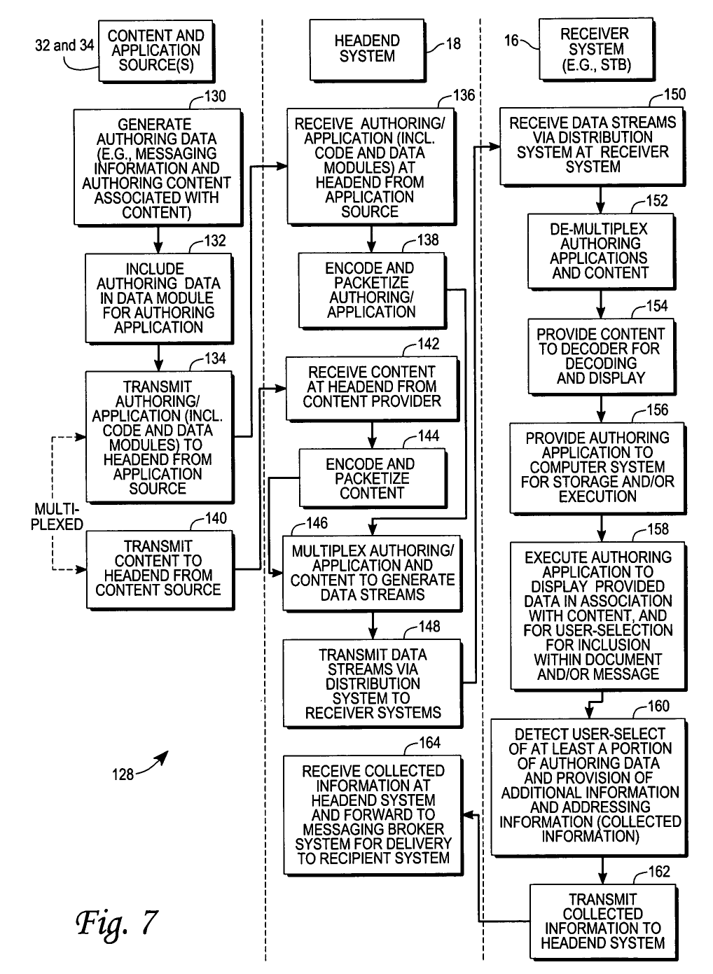

FIG. 7 is a flowchart illustrating a method 128, according to an exemplary embodiment of the present invention, to enable user authoring of content within an interactive television environment 10, such as that illustrated in FIG. 1. While certain operations and functions are described herein as being performed by specific systems within the interactive television environment 10, it will be appreciated that these functions and operations may be performed by systems other than those described as performing the operations with respect to FIG. 7.

The method 128 commences at block 130 with the generation of authoring data 78, for example by the authoring data application 94 at a content source 32. The authoring data 78 is furthermore associated with content data (e.g., a television content) by the authoring data application 94. The association between the authoring data 78 and the content data may be achieved in a number of ways. For example, the authoring data application 94 may time stamp the authoring data 78, this time stamp information later being utilized to associate the authoring data 78 with appropriate content data. The authoring data application 94 may also include content identification information within the authoring data 78 so as to create an association of the authoring data 78 with content data. For example, metadata is associated with a particular television show. A matcher process (not shown) then, based on the metadata, decides what authoring data to send concurrently with which content data of the television show. Specifically, consider the example where the television show is a Disney cartoon. In this example, the metadata associated with the show may contain scene by scene information that identifies what characters form part of a respective scene. The authoring data application 94 may provide authoring data 78, in the form of SMS content or drawing graphics for example, that is relevant to the characters in each broadcast scene.

In yet a further embodiment, the association of the authoring data 78 with the content data may be achieved by communication of both of these data types in a substantially concurrent manner from the headend system 18. In another embodiment, the authoring data 78 may be time coded so that, when content data (e.g., a television show) with which the authoring data 78 is associated is broadcast, the authoring data 78 is triggered by a show time code of the content data. In an even further embodiment, content data (e.g., for a particular television show) may contain triggers (e.g., Advanced Television Enhancement Forum (ATVEF) triggers) that are recognized by the authoring data application 94, and utilized by the authoring data application 94 to identify appropriate authoring data 78 to be sent to when a particular trigger is recognized as being broadcast.

At block 132, the authoring data application 94 includes the authoring data 78 within a data module 74, the data module 74 being associated with the authoring application 98. In an alternative embodiment, the application updating system 100 may operate to include the authoring data 78 within an appropriate data module 74.

At block 134, the application updating system 100, at an application source 34, transmits directory, code and data modules 70-74 to an application server 22 of the headend system 18 via the network 36.

Turning now to operations of the headend system 18, at block 136, an appropriate application server 22 receives the directory, code, and the data modules 70-74 for the authoring application 98 from the application source 34. At block 138, and as described above with reference to FIG. 2, the broadcast server 20 encodes and packetizes the various modules 70-74 that constitute the authoring application 98.

Returning to the source system 12, at block 140, a content source 32 transmits content data (e.g., a television image data) to the headend system 18, this content data being received at the headend system 18 at block 142. At block 144, a broadcast server 20 of the headend system 18 again encodes and packetizes the received content data.

Advancing now to block 146, the multiplexer 50 of the broadcast server 20 multiplexes the modules 70-74 of the authoring application 98 and the content modules 76 to generate a data stream 68 that is included within a transmission signal, as discussed above with reference to FIG. 3. At block 148, the broadcast server 20 then transmits the generated data stream 68 as a transmission signal via a distribution system 14 to one or more receiver systems 16.

Turning now to operations performed at receiver system 16, according to exemplary embodiment to the present invention, at block 150 a set-top box 38 of a receiver system 16 receives the generated data stream 68. For example, the set-top box 38 may be coupled to an antenna or a satellite dish that feeds an appropriate input signal to the input 56 of the set-top box 38, as described above with a reference to FIG. 2. At block 152, the demultiplexer 58 of the set-top box 38 demultiplexes the modules 70-74 of the authoring application 98, and the content modules 76 that are included within the data stream 68. At block 154, the demultiplexer 58 provides the content data, as extracted from the content modules 76, to the audio and video decoder 60 for decoding in order to generate a display signal. The display signal is communicated from the decoder 60 to the display device 42, associated with the set-top box 38. At block 156, the multiplexer 58 provides the modules 70-74 of the authoring application 98 to the computer system 64 of the set-top box 38 for storage and/or execution.

At block 158, the computer system 64 assembles the code modules 72; utilizing information contained in the directory modules 70, to reconstitute (or assemble) the authoring application 98 and then commences execution of the authoring application 98. The execution of the authoring application 98 operates on and utilizes the data contained within the data modules 74. Specifically, the authoring data parser 112 of the authoring application 98 operates to extract the authoring data 78 from the data modules 74 and to provide the authoring data 78, in association with content (e.g., a television signal), for potential user selection, user editing and inclusion within authored content 88 (e.g., a message or a document). As described above with reference to FIG. 6, the authoring data parser 112 extracts the authoring data 78 from the data module 74 and communicates this to the authoring data display module 120, which presents the authoring data 78 to a user.

At block 160, a user selection of at least a portion of the authoring data 78 is optionally detected. Alternatively, the authoring data 78 may automatically be included within the authored content 88, without specific user selection or input. Where user selection is detected, the user input module 126 of the authoring application 98 enables a user to select a portion, or all of, the authoring data 78. For example, the user, utilizing the user input module 126, may select a goal score to be included within a message. The user may furthermore optionally select any alphanumeric, image, video or audio data 80-86 for inclusion within the authored content 88. Furthermore, at block 160, the user may select multiple portions of the authoring data 78. For example, FIG. 4 illustrates the authored content 88 as including two portions of authoring data 78. The multiple portions of authoring data 78 included within authored content 88 furthermore need not be of a uniform media type, but may be of multiple media types.

At block 160, the user provision of additional information (e.g., user-generated text or other media data) and addressing information is (e.g., an email or SMS address) is also detected. Conveniently, the portions of the authoring data 78, the additional information and the addressing information may collectively be referred to as “collected information”, in one embodiment of the present invention.

At block 162, the collected information is then transmitted by the authoring application 98 from the receiver system 16 back to the headend system 18 via the above-described return channel.

At block 164, the headend system 18, and more specifically the service gateway 102, receives the collected information and may optionally forward the collected information, as an appropriately formatted message, to the messaging broker 106 for eventual delivery to a recipient system (e.g., a user device 110).

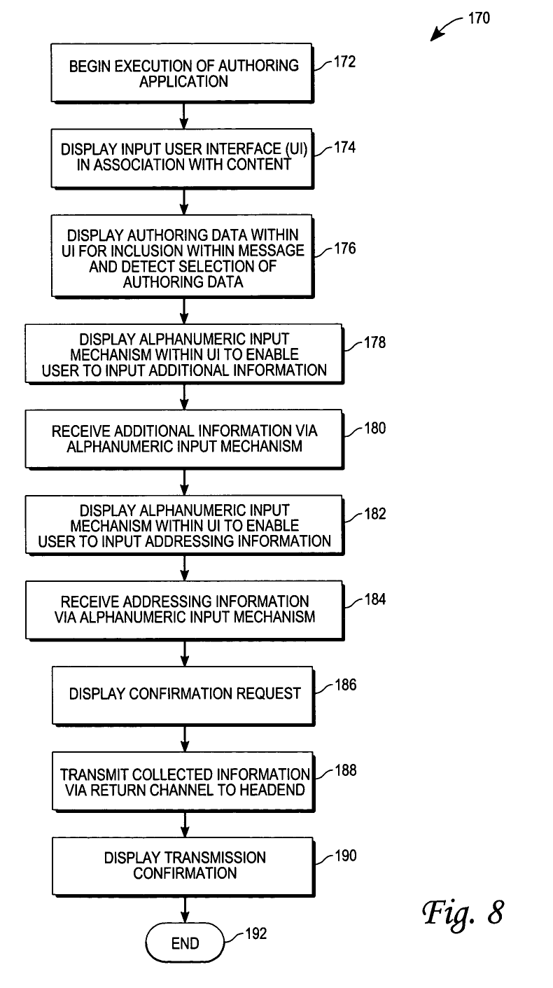

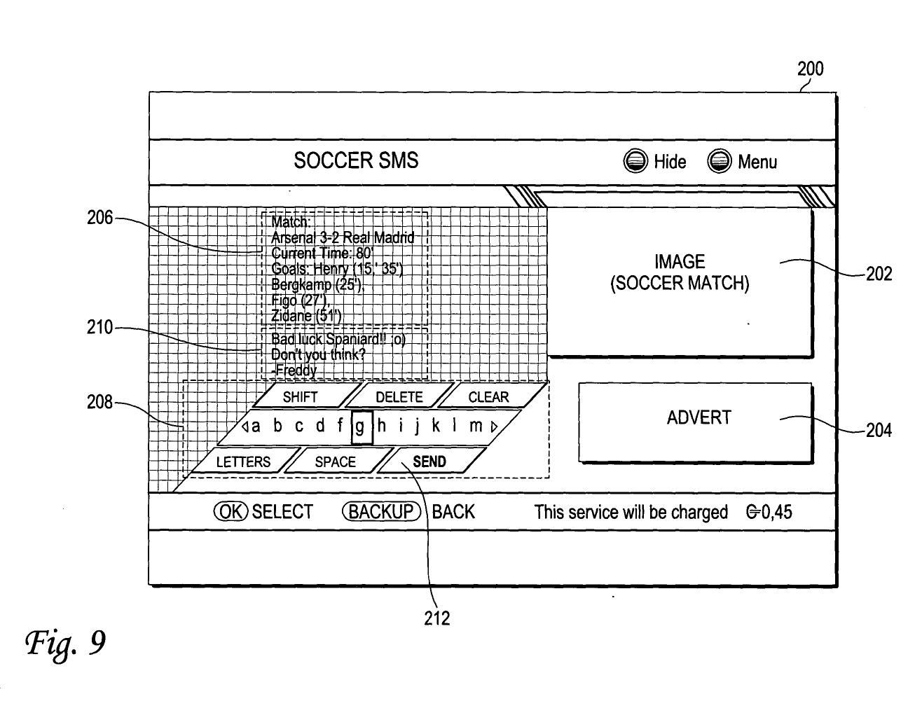

FIG. 8 is a flowchart illustrating method 170, according to an exemplary embodiment of the present invention, to generate authored content 88 that includes authoring data 78. The method 170 can be performed by the authoring application 98, described above with reference to FIG. 6. The method 170 is also described with reference to a series of user interfaces illustrated in FIGS. 9 through 14.

The method 170 commences at block 172 with the execution of the authoring application 98 by, for example, a computer system 64 included within a set-top box 38. At block 174, the user interface module 118 of the authoring application 98 displays an input user interface, which presents content (e.g., a television image) to the user. Specifically, the content receiver and modifier 116 communicates content data to the content display module 124 of the user interface module 118 to achieve the display of the content. FIG. 9 illustrates an exemplary input user interface 200 that may be displayed by the authoring application 98 at block 174. As will be noted from FIG. 9, the user interface 200 displays an image 202, for example a television image of a sporting event such as a soccer match. This image may be included within the user interface 200 by the computer system 64 executing the authoring application 98, the relevant image having been received from the audio and video decoder 60. In an alternative embodiment, the image need not be displayed within the user interface 200, but may be merely shown in association with the user interface. For example the user interface 200 may be overlaid on content, such as a television image. In this case, the computer system 64 may execute the authoring application 98 to overlay the interface 200 over an image that is provided to the display device 42 directly from the audio and video decoder 60.

Referring again to FIG. 9, the user interface 200 is also shown to include an advertisement 204. This advertisement 204 may be displayed by the advertisement display module 122 of the authoring application 98, utilizing advertisement data received from the advertisement parser and generator 114. In one embodiment of the invention, the authoring data 78 that is received by the authoring application 98 may be contextual to an advertisement 204 that is included within a broadcast content. In this scenario, a user may be prompted to generate authored content 88 that includes authoring data 78 related to the advertisement 204, and optionally to communicate this authored content 88 (e.g., as an SMS message, or e-mail message) to an advertising entity. Consider that the authored content 88 may contain an answer to a question that is posed by advertisement 204. The correct answer is included within the authoring data 78, and is selectable by the user from within the authoring data 78 for inclusion within the authored content 88.

Returning to FIG. 8, at block 176, the authoring application 98 displays authoring data 78 within the context of the user interface 200 for inclusion within authored content 88. Referring to FIG. 9, in one exemplary embodiment, the authoring data 78 includes statistical information 206 (and possibly other alphanumeric or text information) pertaining to a soccer match that is being shown via the image 202. The statistical information 206 is extracted by the authoring data parser 112 from data modules 74 included within data streams 68 received at the set-top box 38. The authoring data parser 112 then communicates the extracted authoring data 78 to the authoring data display module 120 of the user interface module 118 for inclusion within the user interface 200. Accordingly, the statistical information 206 is presented by the authoring application 98 for user selection and inclusion within authored content 88.

It will furthermore be noted that the statistical information 206 is associated with, and contextual to, content in the exemplary form of the image 202.

In the exemplary user interface 200 illustrated in FIG. 9, the statistical information 206 is automatically included within authored content 88 and is as such automatically included as text within a message that a user may compose utilizing the interface 200. In the exemplary user interface 200, the user-action of initiating a composition of a message (e.g., an SMS message) may be viewed as constituting the user selection of the authoring data 78, in the form of the statistical information 206, for inclusion within the authored content 88. In other embodiments of the present invention, the user, via an appropriate interface, may be presented with the option of selecting only a portion of the authoring data 78 for inclusion within the authored content 88. For example, referring again to the exemplary user interface 200 shown in FIG. 9, in an alternative embodiment, check boxes may be displayed adjacent respective statistical information items, and user selection of the check boxes may enable the user selectively to include and exclude text from the authored content 88.

Returning again to FIG. 8, at block 176, user-selection of authoring data 78, for inclusion within the authored content 88, is accordingly performed. As noted above, the selection of the authoring data 78 at block 178 may be performed automatically by the authoring application 98, as is the case for the example provided in FIG. 9. Alternatively, a user-selection of portions (or the whole) of the authoring data 78 for inclusion within the authored content 88 may be facilitated.

Advancing now to block 178 in method 170, the user input module 126 of the application 98 displays an alphanumeric input mechanism within the user interface, so as to enable user input of additional information for inclusion within the authored content 88. Referring again to the exemplary user interface 200 shown in FIG. 9, an exemplary alphanumeric input mechanism in the form of a virtual keyboard 208 is shown to be presented to a user within the context of the interface 200. The virtual keyboard 208 may be navigated utilizing a standard remote control, for example, to communicate with the set-top box 38. The virtual keyboard 208 may furthermore include a full set of alphanumeric characters, as well as additional symbols that are commonly used in a specific message type (e.g., symbols that are typically used within SMS messages).

At block 180 of the method 170, the authoring application 98 receives additional information for inclusion within the authored content (e.g., to be included within an alphanumeric message). Referring again to the exemplary user interface 200 illustrated in FIG. 9, the interface 200 is shown to include a message editor display 210 that displays the body of an alphanumeric message that may be inputted by a user utilizing the virtual keyboard 208. The set-top box 38 may also have an associated physical keyboard via which a user can also input alphanumeric text for display within the message editor display 210. Exemplary alphanumeric input within the message editor display 210 is illustrated in FIG. 9, this input having been generated by a user utilizing the virtual keyboard 208. A user, having inputted alphanumeric information, may select the send button 212 within the virtual keyboard 208, the selection of the send button 212 indicating that input of alphanumeric information into the message editor display 210 has been completed, and that the user now wishes to send appropriate message.

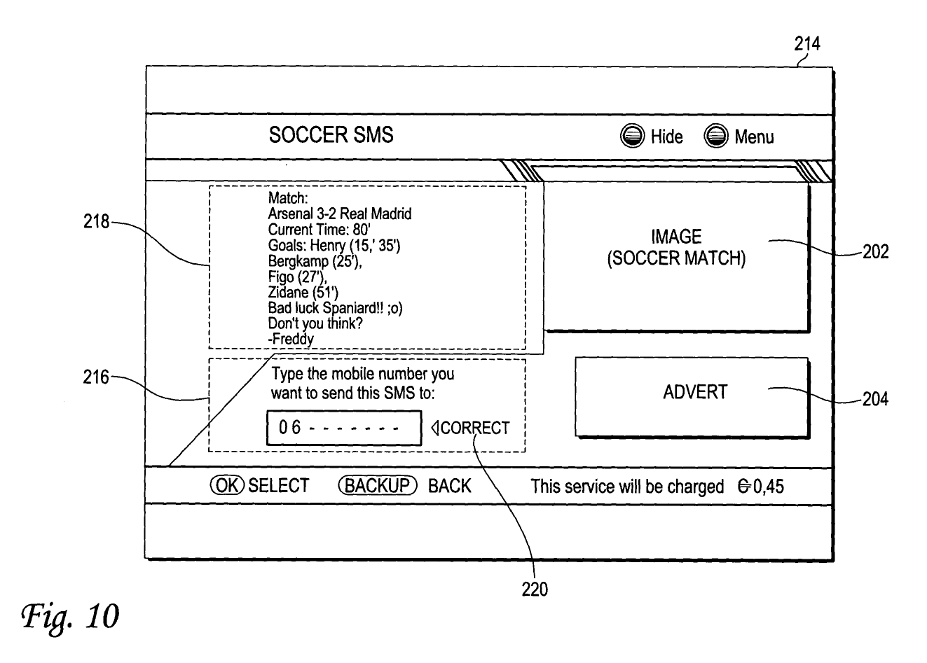

At block 182 of method 170, the user input module 126 of the messaging application 98 displays an alphanumeric input mechanism within a user interface to enable a user to input addressing information. FIG. 10 illustrates an exemplary user interface 214 that may be generated by the user interface module 118 of the authoring application 98, responsive to user selection of the send button 212 (FIG. 9). The user interface 214 may, in addition to including the image 202 and the advertisement information 204, also include a telephone number input field 216. A user may input a mobile telephone number into the input field 216 utilizing, for example, a remote control or a physical keyboard associated with the set-top box 38. Alternatively, the user may choose a mobile telephone number from a list of the last 10 mobile telephone numbers used in connection with the authoring application 98.

The authoring application 98 may also provide the user with the option of sending a message including the authored content 88 to multiple addressees (e.g., five telephone numbers) concurrently. Having entered a mobile telephone number into the input field 216 a user may then select a correct button 220 to conclude input of the relevant mobile telephone number. It will also be noted from FIG. 10 that the user interface 214 displays the authoring data 78 and the user-inputted information 92 is shown within a text display area 218. In this example, the authoring data 78 and the user-inputted information 92 are combined to constitute the alphanumeric body of a message.

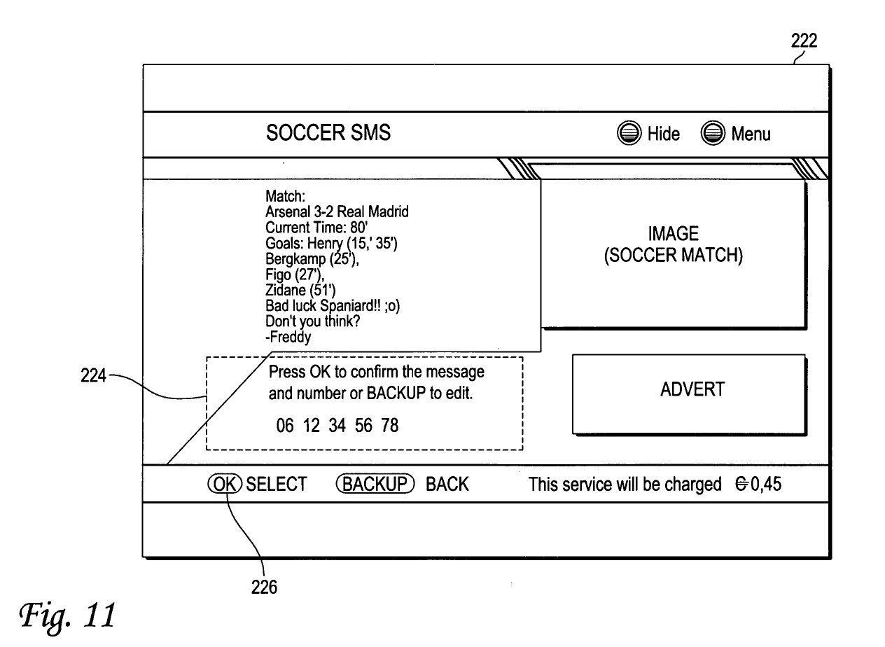

At block 186 of the method 170, the user interface module 118 of the authoring application 98 displays that a confirmation request to the user, confirming the content and addressing information for the message including the authored content 88. FIG. 11 illustrates an exemplary confirmation user interface 222 that includes a confirmation request 224. User selection of the OK button 226 communicates the user confirmation to the authoring application 98.

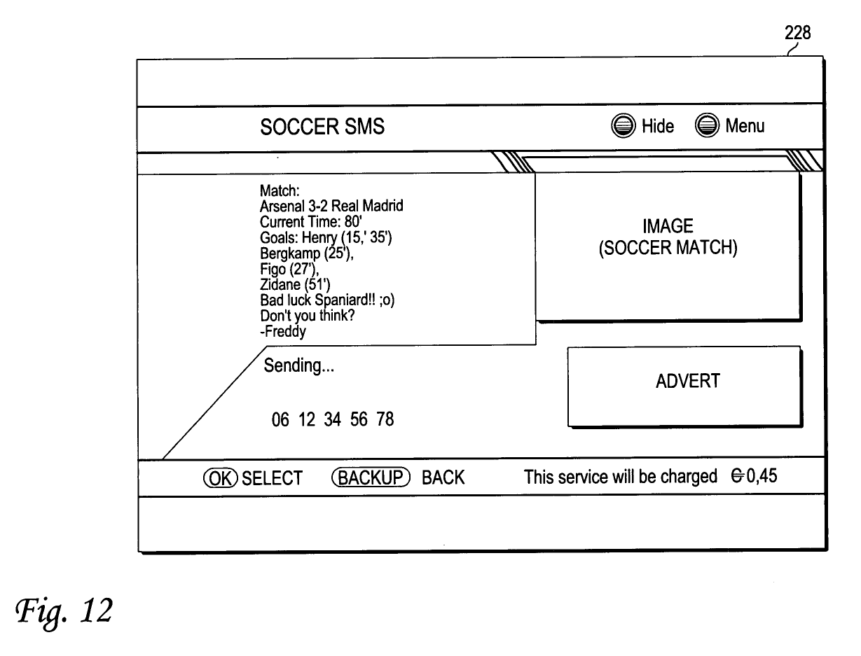

At block 188, the authoring application 98 then transmits the collected information (e.g., the addressing information 90, authoring data 78, and user-inputted information 92) as a message (e.g., an SMS message) via the return channel to the headend system 18, as described above. FIG. 12 illustrates an exemplary sending user interface 228 that may be displayed by the user interface module 118 of the authoring application 98 during transmission of the message to the headend system 18.

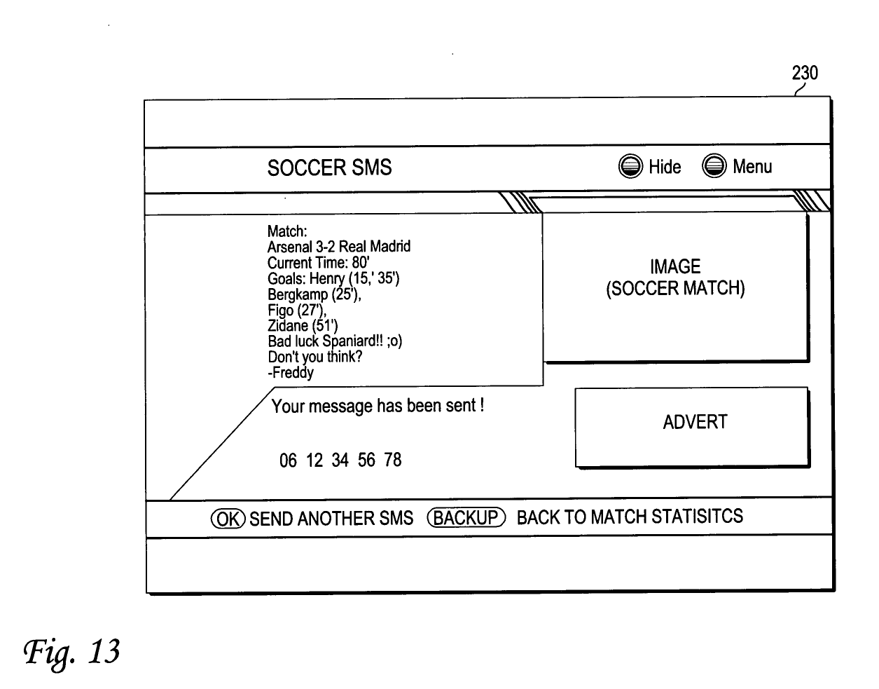

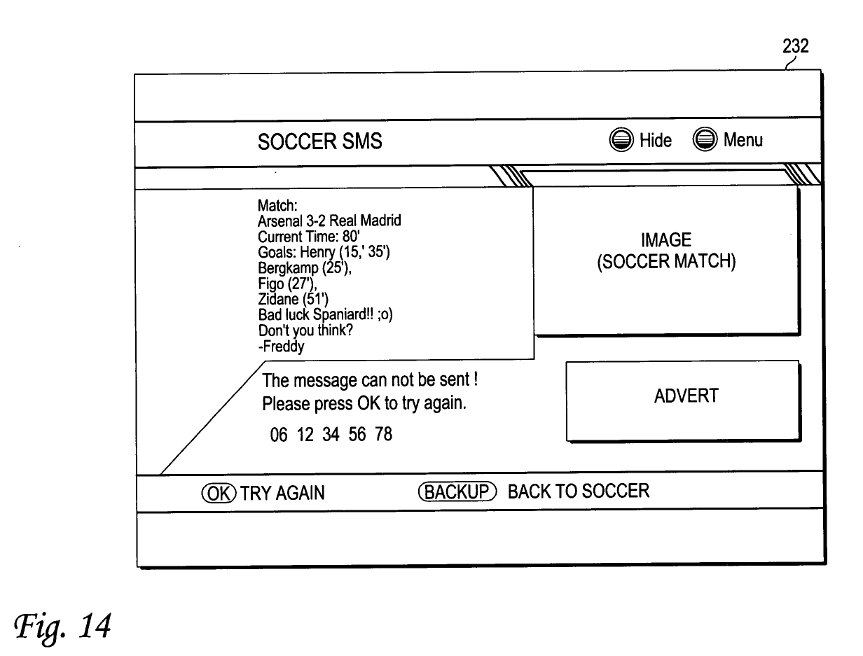

At block 190, the interface module 118 of the authoring application displays a confirmation interface to the user to confirm that the relevant message has been sent, or that there has been a problem with the transmission of the message. FIG. 13 illustrates an exemplary positive confirmation and a user interface 230, communicating that a relevant message has been successfully sent. FIG. 14, on the other hand, illustrates a negative confirmation interface 232 indicating that the message has not been sent, and prompting the user to attempt retransmission of the relevant message. The method 170 then terminates at block 192.

The method 170 as discussed above with reference to the flowchart illustrated in FIG. 8, and also with reference to an exemplary embodiment to the present invention in which the authoring application 98 is a messaging application and, more specifically, an SMS messaging application. As described above, the authoring application 98 provides a message editor display 210 into which a user may input alphanumeric information. In one embodiment, both the authoring data 78 and the user inputted information 92 might be displayed within a common editing window, so as to allow the user to edit and manipulate the authoring data 78. As noted from FIGS. 9-14, the exemplary SMS application supports the placement of advertisements. The SMS application also provide preferences and settings mechanisms while a user may define a signature (e.g., name, phone number, etc.) User-preference with respect to utilizing the virtual keyboard 208 or a physical keyboard that may be associated with the set-top box 38 is also supported. The SMS application may also include a phonebook feature that allows a user to store and recall a predetermined (e.g., last used) phone numbers. As noted above, the SMS application may also provide functionality that allows a user to send a message to multiple recipients with a single send action. The SMS application may also include a collection of pre-written alphanumeric information (e.g., “happy birthday, Merry Christmas”, etc.) that may be presented to a user for inclusion within the authored content 88. The SMS application may also provide an “easy text recognition” input feature, which enables a user quickly to input text utilizing a remote control for an embodiment to the present invention where the virtual keyboard 208 is displayed in the form of a mobile telephone keypad. The “easy text recognition” input feature, inter alia, may attempt to recognize words or phrases that a user is attempting to input, and insert these words, or provide a selection of words from which a user may select a word for inclusion within the inputted information 92. The SMS application may also allow a user to store a message, or a portion of a message, for later reuse in other messages and let a user to elect pre-formulated phrases for input into a message body, utilizing only inputting a certain phrase or a sequence of alphanumeric keystrokes.

In the exemplary embodiment where the authoring application 98 comprises a messaging application, the authoring application 98 may incorporate messaging logic 127, as illustrated in FIG. 6. The messaging logic 127 embeds necessary data within the content 88 to enable communication of the authored content 88 as a message. For example, messaging logic 127 may include the following data elements within a message:

1. Recipient address information (e.g., telephone number, email address, instant messaging handle etc).

2. A message body,

3. A sender identifier (e.g., a mobile telephone number, email address or instant message handle etc),

4. Gateway technical parameters (e.g., the address of the service gateway 102), and/or

5. Gateway account data (e.g., reference and volume data, password data etc for the service gateway 102),

The messaging logic 127 may also operate to request status information via the return channel from the service gateway 102 so as to enable generation of status and confirmation interfaces, examples of which are discussed above.

Where the user input module 126 supports the virtual keyboard 208, one exemplary embodiment may provide three types of virtual keyboards, namely:

1. A one-dimensional keyboard, where the user scrolls through a list of letters that are displayed, as the user moves backwards and forwards through the list. An example of this one-dimensional keyboard is illustrated in FIG. 9.

2. A two-dimensional keyboard, where the user can navigate left and right, up and down through a matrix of letters (e.g., arranged as a QWERTY keyboard). In this embodiment, different sets of characters may be displayed and triggered by appropriate buttons.

3. A numerical keyboard (e.g., arranged to represent a keypad of a mobile telephone) allows users to press a single virtual key several times to make one letter appear. For example when the numeric key “2” is pressed twice, the letter “b” appears. The numeric keypad may be associated with an auto-completion mechanism.

The exemplary scenario described above involves the generating and editing of data that is contextual to a football match that is being presented as a TV show. Of course, alternative embodiments of the present invention allow a user to generate and select/edit data that is contextual to a wide variety of content. The data is available for inclusion within the authored content 88 may, in various embodiments of the present invention, be contextual to content that is concurrently being delivered to user. Various examples of content in conjunction with which various embodiments of the present invention may be utilized are discussed below:

1. Sports: When watching a sports event, a user utilizing the authoring application is invited to send a pre-authored, or supplemented, message pertaining to the sports event (e.g., a score in a soccer match).

2. News shows: In this use scenario, the authoring application 98 may present authoring data 78 that includes current news or the latest news dispatch. In this embodiment, the authoring application 98 may display headlines or a set of current news dispatches, and enable a user to select one or more of these news items for inclusion within a message (e.g., an SMS message or email).

3. Reality television shows: For example, on a 24×7 channel, or on a daily summary, the authoring application 98 may display a list of the latest events that have occurred within the reality television show (e.g., “November 23, 2 PM: Sarah kissed Robert, but said “I still love John”). In this case, the user may be presented the option of supplementing and/or editing a summary of a particular show, or quotes from a particular show.

4. Television series shows: In this scenario, the authoring application 98 may present a user with a summary of an episode or a main event that occurred during the series (e.g., event or episode selected by a user), the summary being presented preset text for inclusion within a message body.

5. Talk shows: A selected line delivered by a participant within the show may be presented as a pre-authored object line, or content, for inclusion within the body of a message.

6. Media releases: During a television broadcast, information concerning a media release (e.g., publication of a book, commencement of a theatre show, release of a DVD or CD etc.) may be presented for inclusion within a message. For example, the title of a new book may be presented. In addition, options to buy merchandise associated with the media event (e.g., a CD) may be presented by the authoring application 98. IThe authoring data 78 that is presented for inclusion message may relate to a purchase of the merchandise or product associated with a media event. For example, the authoring data 78 may state “A friend of yours offers you a new DVD “Lord of The Rings (extended version)” call 0 100-503-503 (local call fee) or send an email and give your details to receive your gift.” Accordingly, a particular user may author and send a message to a friend regarding the purchase of an item that the user believes the friend may be interested in acquiring.

7. Commercial messages: The supplied authoring data 78 may be linked, for example, to the release of a new product. For example, the authoring data 78 may state “This message is offered to you by Company X, the manufacturer of Product Y.”

8. Text chat messages: In a further embodiment, the messages authored utilizing the authoring application 98 may be “text chat” messages. In this embodiment, the authoring application may facilitate user participation in “chat rooms” dedicated to specific broadcast television content. For example, while the television show “X-Files” is being broadcast, the authoring application 98 may provide a user with the option to enter a chat room dedicated to an episode of the “X-Files” that is currently being broadcast. In this way, the authoring application 98 may enable a user, in a near real-time manner, to engage in chat conversations regarding broadcast television program. In a further embodiment, the authoring application 98 may also include voice-over-IP (VoIP) capabilities so as to allow users to exchange voice messages, either in combination with alphanumeric data or as pure voice data. During the show, the text chat provides the option of not audibly interrupting a viewing experience.

9. Graphic content: In a further embodiment to the present invention, the authoring data 78 may include logos, images or other graphic elements that are contextual, or relevant to, concurrently distributed content. Such logos, images or graphical elements may be made available via the authoring application 98 for inclusion within authored images. For example, certain images depicting characters or objects within a television show could be broadcast, or made available within the authoring application 98 for user selection and inclusion within authored content 88. User may, in one exemplary embodiment, select an icon associated with a hero of a television show, and include this icon in a message (as opposed to typing in the hero's name).

10. Audio data: In a further exemplary embodiment, and as alluded to above, the authoring data 78 may include audio data 86. In one exemplary embodiment, the audio data 86 may be a contextual ring tone (e.g., music associated with a television show) that can be played at the set-top box 38, or that can alternatively be transferred to another user device (e.g., a cell phone) for playback via that further user device 110. Again, utilizing the television show “X-Files” as an example, the theme song for this show could be presented as a ring tone for inclusion within an SMS message communicated from the authoring application 98 to a cell phone of an identified recipient. The recipient, upon receipt of the message, stores the relevant ring tone on the cell phone. In other exemplary embodiments, the authoring data 78 may include multi-media data, such as audio, picture or video data that is associated with, related to, or contextual to other distributed content (e.g., a broadcast television show).

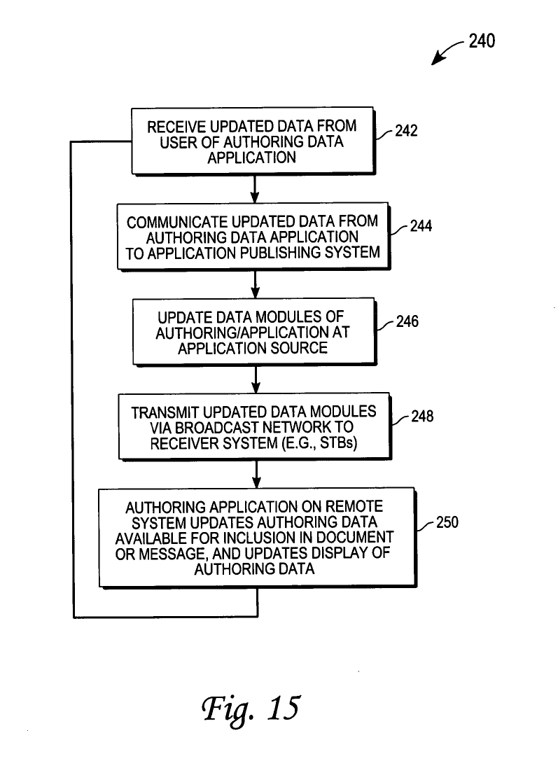

FIG. 15 is a flowchart illustrating method 240, according to an exemplary embodiment of the present invention, to associate authoring data 78 with other distributed content and to communicate the authoring data 78 to a user for inclusion within authored content 88.

The method 240 commences at block 242 with the receipt, by the authoring data application 94, of data from a user of the application 94 for communication to a user of the authoring application 98. For example, the user of the authoring data application 94 may be viewing broadcast content, and manually input information that is pertinent and/or contextual to the broadcast content. For example, during the broadcast of a soccer match, the user of the authoring data application 94 may manually input a score achieved by each of the sides participating in the soccer match. In an alternative embodiment, the authoring data application 94 may automatically identify updated data to be communicated to the authoring application 98. For example, the authoring data application 94 may receive data feeds from a number of connected sources (not shown), and be programmed selectively to include such information within the updated data that is to be communicated to the authoring application 98. In yet a further embodiment, the authoring data application 94 may employ a hybrid of automated and manual selection of data to be presented to the authoring application 98.

At block 244, the updated data is communicated from the authoring data application 94 to the application updating system 100, as illustrated in FIG. 5. FIG. 5 illustrates the authoring data application 94 as being deployed on a computer system 96 at a content source 32, and the application updating system 100 as residing at application source 34. It would of course be appreciated that these applications and systems need not be deployed at content sources 32 and application sources 34 as illustrated in FIG. 5, and could be deployed at any one of a number of systems within the environment 10.

At block 246, the application updating system 100 updates data modules 74 that are associated with the authoring application 98, with the updated data located at block 244. Specifically, with reference to FIG. 3, the data modules 74 are updated to include authoring data 78 that corresponds to the updated data received at block 244.

At block 248, the application updating system 100 communicates the updated data modules 74 to the application servers 22 and broadcast servers 20, from where these data modules 74 are communicated via the distribution system 14 to receiver systems 16 that include, in one exemplary embodiment, set-top boxes 38.

At block 250, an authoring application 98, executing at a receiver system 16, updates authoring data 78 which is stored at the receiver system 16 for inclusion within authored content 88. At block 250, the display of the authoring data 78 may also be updated to display the most recently received authoring data 78.

In conclusion, one embodiment of the present invention described above allows a broadcaster, or other publisher or content provider, to create and publish contextual data for content that is distributed to a receiver system. Further, one embodiment of the invention enables a user at a receiver system to generate authored content that includes the published contextual data or at least a portion of such contextual data.

While the above embodiment of the present invention have been described above as providing a simple text editor (e.g., for generating or modifying alphanumeric data), other embodiments of the present invention may have more sophisticated editors, such as a graphics, video or music editors. One aspect of this invention proposes providing such editors, as part of the authoring application 98, with authoring data 78 that is pre-authored or pre-composed. This enables a user to create authored content 88 utilizing a simplified process that nevertheless generates sophisticated authored content 88. The provision of pre-authored or pre-composed authoring data 78 becomes particularly advantageous where the receiver system 16 includes a set-top box 38, with which a user interacts utilizing a remote control, or where a user is not adept at utilizing sophisticated authoring software. Accordingly, one aspect of the present invention proposes presenting a user at a receiver system 16 with a choice of pre-authored or pre-composed authoring data 78 (e.g., words, sentences, drawings, photographs, melodies, tunes, videos etc) that can be assembled into authored content 88.

The choice of pre-authored or pre-composed authoring data 78 presented to a user for inclusion within the authored content 88 may change based on other content (e.g., a television program) that is being concurrently broadcast or concurrently viewed by user. Examples of such pre-authored authoring data 78 may include:

1. Default sentences that are presented for inclusion within text messages;

2. Default graphics—for example those of football teams can be included into a composed message; and/or

3. A ring tone for a movie or music video that is currently viewed.

With respect to the “default graphics” embodiment discussed above, a graphics editor 117 may be incorporated within the authoring application 98. The graphics editor 117 allows a user to compose an original graphical image as authored content 88 utilizing a collection of pre-composed graphical elements that are communicated to the receiver system 16 from the source system 12. These graphic include pre-drawn shapes and figures and the graphical editor 117 operates so as to allow a user to color or shade such shapes and figures, modify such shapes and figures, and combine such shapes and figures into new graphics. Such graphics may then be communicated by the authoring application 98 to a recipient. For example, when broadcasting a children's television show, it is envisaged that graphic elements related to the television may be communicated to the authoring application 98, and presented to a child viewing the television program. The child, utilizing the remote control or a keyboard, may then modify (e.g., by coloring) the graphic elements. The modification process is facilitated by a graphics editor 117 included within the authoring application 98.

Audio data could be communicated receiver system 16, either in conjunction with or without associated context, and made available to a user for inclusion within authored content 88 or used within the original authored content 88 as in an audio editor 119.

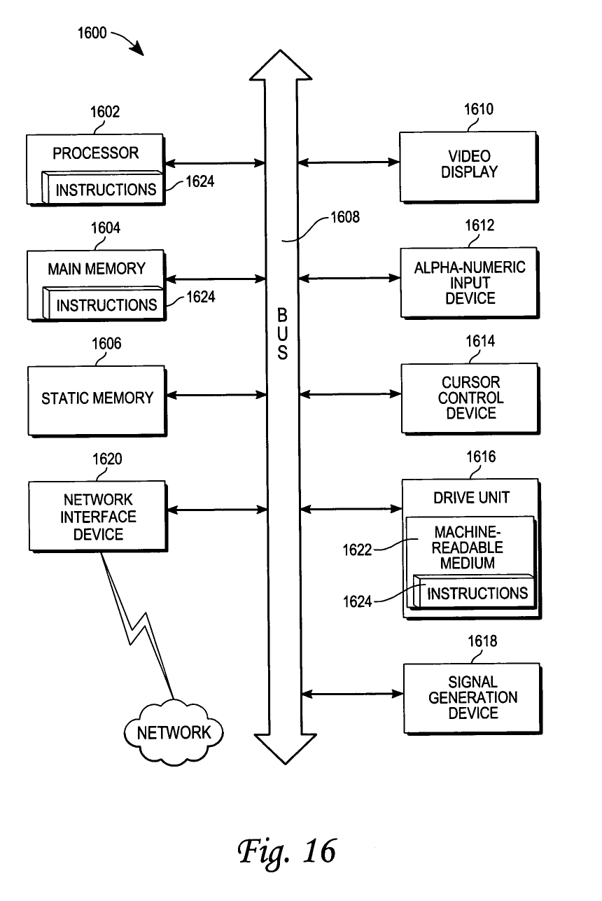

FIG. 16 shows a diagrammatic representation of machine in the exemplary form of a computer system 1600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server, personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1600 includes a processor 1602 (e.g., a central processing unit (CPU) a graphics processing unit (GPU) or both), a main memory 1604 and a static memory 1606, which communicate with each other via a bus 1608. The computer system 1600 may further include a video display unit 1610 (e.g., a liquid crystal display (LCD) or a cathode ray tube (CRT)). The computer system 1600 also includes an alphanumeric input device 1612 (e.g., a keyboard), a user interface (UI) navigation device 1614 (e.g., a mouse), a disk drive unit 1616, a signal generation device 1618 (e.g., a speaker) and a network interface device 1620.

The disk drive unit 1616 includes a machine-readable medium 1622 on which is stored one or more sets of instructions (e.g., software 1624) embodying any one or more of the methodologies or functions described herein. The software 1624 may also reside, completely or at least partially, within the main memory 1604 and/or within the processor 1602 during execution thereof by the computer system 1600, the main memory 1604 and the processor 1602 also constituting machine-readable media.

The software 1624 may further be transmitted or received over a network 1626 via the network interface device 1620.

While the machine-readable medium 1692 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to included, but not be limited to, solid-state memories, optical and magnetic media, and carrier wave signals.

Thus, a method and system to enable user authoring of content within an interactive television environment have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method to enable user-authoring of content within an interactive television environment, the method including:
at a source system, communicating television content to a receiver system, the television content to be presented to a user by the receiver system;
at the source system, communicating authoring data, associated with the television content, to the receiver system; and
at the source system, communicating an authoring application to the receiver system, the authoring application being executable by the receiver system to enable the user to author content utilizing the authoring data.

2. The method of claim 1, including, at the source system, receiving the authoring data from a content source, and associating the authoring data with the television content.

3. The method of claim 1, wherein the authoring data is contextual to the television content.

4. The method of claim 1, wherein the authoring application comprises a messaging application executable by the receiver system to enable the user to include the authored content within a message, and to enable the user to communicate the message.

5. The method of claim 1, wherein the television content, the authoring data, and the authoring application are communicated from the source system as a combined communication.

6. The method of claim 5, wherein the combined communication comprises a broadcast.

7. The method of claim 5, wherein the source system includes a multiplexer to multiplex the television content, the authoring data, and the authoring application.

8. The method of claim 1, including, at the receiver system, executing the authoring application, receiving from the user identification of at least a portion of the authoring data associated with the television content, and including the portion of the authoring data within the authored content.

9. The method of claim 8, including executing the authoring application to present a user interface for display on the receiver system, the user interface to receive the user identification of the portion of the authoring data to be included within the author content.

10. The method of claim 9, wherein the user interface presents the authoring data in association with the television content at the receiver system for user-selection.

11. The method of claim 1, including, at the receiver system, executing the authoring application to transmit the authored content as part of a message to a recipient.

12. The method of claim 11, including executing the authoring application to prompt the user to provide identification information for the recipient.

13. The method of claim 1, wherein the receiver system is an interactive television system, and the authoring application is an interactive television application.

14. The method of claim 1, including, at the receiver system, executing the authoring application to present a virtual keyboard for display on the receiver system, the virtual keyboard to facilitate alphanumeric input by a user.

15. The method of claim 1, including, at the receiver system, executing the authoring application to receive alphanumeric input from a user, and to identify the alphanumeric input for inclusion within the authored content.

16. The method of claim 1, including, at the receiver system, executing the authoring application to receive a recipient identifier to identify a recipient of a message that includes the authored content.

17. The method of claim 16, wherein the message comprises a SMS message, and the recipient identifier comprises a telephone number.

18. The method of claim 16, wherein the message comprises an e-mail message, and the recipient identifier comprises an e-mail address.

19. The method of claim 16, wherein the message comprises an instant message, and the recipient identifier comprises an instant message handle.

20. The method of claim 16, including executing the authoring application at the receiver system to communicate the message via a return path to the source system.

21. The method of claim 20, wherein the return path is a bi-directional communication channel.

22. The method of claim 1, wherein the authoring data includes at least one of a group of information types including numeric, alphanumeric, picture, logo, icon, video, and audio data.

23. A system including:
a source system to distribute content to a receiver system, the source system further to distribute auxiliary information, associated with the content, to the receiver system; and
a receiver system to receive the auxiliary information from the receiver system together with a recipient identifier, and to cause the auxiliary information to be included within a message to be communicated to a recipient identified by the recipient identifier.

24. The system of claim 23, wherein the source system includes a broadcast system to broadcast the content to the receiver system.

25. The system of claim 24, wherein the broadcast system is further to broadcast the auxiliary information to the receiver system.

26. The system of claim 23, wherein the source system is to distribute a messaging application to the receiver system, the messaging application to present the auxiliary information for communication to the receiver system.

27. The system of claim 26, wherein the source system is to distribute the messaging application in conjunction with the content and the auxiliary information.

28. The system of claim 23, wherein the receiver system is to communicate the auxiliary information to a messaging system for inclusion within the message.

29. The system of claim 23, wherein the message is an SMS message, and the recipient identifier is a telephone number.

30. The system of claim 23, wherein the message is an e-mail message, and the recipient identifier is an e-mail address.

31. The system of claim 23, wherein the message is an instant message, and the recipient identifier is an instant message handle.

32. An authoring application for execution on a client machine, the authoring application including:
a receiver component to receive auxiliary information, associated with the broadcast content;
a display component to display the auxiliary information to a user, and to receive user identification of at least a portion of the auxiliary content; and
a messaging component to identify the portion of the auxiliary content to a messaging system for inclusion within a message.

33. The authoring application of claim 32, wherein the messaging component is to communicate the portion of the auxiliary content to the messaging system.

34. The authoring application of claim 32, wherein the display component is to receive alphanumeric input from the user for inclusion within the message, and the messaging component is to communicate the alphanumeric input to the messaging system.

35. The authoring application of claim 34, wherein the display component is to display a virtual keyboard via the client machine to a user, the virtual keyboard to facilitate input of the alphanumeric input by the user into the client machine.

36. The authoring application of claim 32, wherein the display component is to receive a recipient identifier identifying a recipient of the message.

37. The authoring application of claim 36, wherein the recipient identifier is selected by a user from a list of stored recipient identifiers.

38. The authoring application of claim 36, wherein the recipient identifier is received as alphanumeric input from the user.

39. The authoring application of claim 32,wherein the messaging component is to communicate with the messaging system of via a return path.

40. The authoring application of claim 39, wherein the return path is a bi-directional communication channel.

41. A machine-readable medium storing a set of instructions that, when executed by machine, causing machine to perform the method of claim 1.

42. A machine-readable medium storing a set of instructions that, when executed by machine, cause the machine to perform any of the methods described herein.
